(19) United States
(12) Patent Application Publication
(10) Pub. No.: US 2017/0147745 A1
(43) Pub. Date: May 25, 2017

(54) METHOD, COMPUTER SYSTEM AND SOFTWARE FOR SELECTING TAG SNP, AND DNA MICROARRAY EQUIPPED WITH NUCLEIC ACID PROBE CORRESPONDING TO TAG SNP SELECTED BY SAID SELECTION METHOD

(71) Applicant: National University Corporation Tohoku University, Sendai-shi, Miyagi (JP)

(72) Inventors: Masao NAGASAKI, Sendai-shi (JP); Kaname KOJIMA, Sendai-shi (JP); Naoki NARIAI, Sendai-shi (JP); Takahiro MIMORI, Sendai-shi (JP); Yosuke KAWAI, Sendai-shi (JP)

(73) Assignee: National University Corporation Tohoku University, Sendai-shi, Miyagi (JP)

(21) Appl. No.: 15/320,438

(22) PCT Filed: Jun. 19, 2015
(86) PCT No.: PCT/JP2015/067686

§ 371 Date: Dec. 20, 2016

(30) Foreign Application Priority Data
Jun. 20, 2014 (JP) 2014-126910
Nov. 1, 2014 (JP) 2014-223834

(51) Int. Cl. G06F 19/22

(52) U.S. Cl. CPC G06F 19/22

(57) ABSTRACT

The present invention provides a selection method of tag SNPs, for constituting a group of nucleic acid probes corresponding to the tag SNPs, the tag SNPs being used for performing imputation of information on SNPs of human genome by using human genome information, the human genome information including information on a group of SNPs, the genotypes of the SNPs being identified in multiple individuals, in which method a sum of mutual informations between tag SNP candidates and target SNPs is used as an index for selecting the tag SNPs, and a computer system based on the principle, a computer program, and a DNA microarray on which nucleic probes corresponding to the tag SNPs selected by the means, and a production method thereof.

### TECHNICAL FIELD

The present invention relates to a field of genetic analysis based on nucleic acids, and more specifically, the present invention provides a means for deducing whole single-nucleotide polymorphism (SNP) information in individual human genome from less SNP information with higher accuracy based on information on SNPs in human genome.

### BACKGROUND ART

It is known that, as our facial features, body shapes, and characteristics vary between individuals, nucleotide sequences encoding genetic codes significantly vary between individuals. A difference in the genetic codes is generally referred to as a polymorphism. Although several types of polymorphisms are known to date, particular attention is currently given to SNPs in conjunction with so-called custom-made medical care.

On the other hand, medical care till now has mainly focused on studying a cause of diseases, developing a therapeutic method, and the like. However, in reality, it is also known that a therapeutic effect varies between individuals.

The custom-made (tailor-made) medical care is a type of medical care where a therapeutic method suitable for physical conditions of individual patients is applied in a so-called custom-made fashion, rather than providing a therapeutic means in a monotonous manner. An essential element determining the physical conditions of the individual patients is provided by individual genetic information. Deciphering human genome has currently revealed various correlations between the genetic information and the physical conditions and diseases. In such circumstances, SNPs are one of human genetic elements drawing the most attention today.

The term “SNP” is an abbreviation of single nucleotide polymorphism and refers to one base difference between individuals. SNP is the most common polymorphism in genes and the number of SNPs in human genome is estimated to be 30 millions or more. Further, SNP is considered to be one of the most important elements determining an individual difference in human. SNP is currently analyzed in relation to diseases, physical conditions, effects of medication, and the like, and significant results have been gained.

If gene analysis is performed in individuals by focusing on SNPs and, as a result, individual hereditary tendencies, for example, susceptibility to diseases considered to be strongly related to a lifestyle habit, such as high blood pressure, diabetes, cancers, heart diseases, and cerebral apoplexy, can be identified, it becomes possible to take a preventive measure by providing active life guidance on meal, exercise, and the like in advance. It is also expected that this can help providing a fruitful life and halt increase of medical care expense. Further, even after falling ill, it is possible to avoid prescribing a needless or dangerous medication in advance if an effect of medication and a risk of side effect are determined in advance by the SNP analysis.

On the other hand, it is becoming clear that, not just one kind of SNP, but multiple SNPs are directly involved in such individual physical conditions in various ways and thus the SNP analysis is preferably performed in a comprehensive manner.

In such circumstances, attempts to apply a DNA microarray which is used as a means for comprehensively analyzing genes, to the SNP analysis of human genome have been conducted.

### CITATION LIST

### Non-Patent Literature

Non-Patent Literature 1: The International HapMap 3 Consortium (2010) Nature 467, 52-58.

### SUMMARY OF THE INVENTION

### Technical Problem

When an SNP analysis is performed using a DNA microarray, a first problem is the number of nucleic acid probes of SNPs to be mounted on the DNA microarray. The nucleic acid probes of SNPs (hereinafter also referred to as “nucleic acid probes”) substantially comprise nucleotide sequence fragments of human genome containing SNP bases, or their complementary chains. 30 millions or more of SNPs are currently known and it is technically difficult and too costly at present to mount all the nucleic acid probes corresponding to these SNPs on the DNA microarray for widely detecting SNPs.

Thus, attempts to reduce the number of the nucleic acid probes to be mounted on the DNA microarray have been made by limiting the nucleic acid probes to those related to human physical conditions, diseases, and the like, and by performing a process called imputation (genotype imputation).

Such attempts are based on the fact that SNPs in the genome are correlated with each other. Highly correlated SNPs are biased to specific regions (haplotype blocks), thus providing an assumption that, by choosing appropriate SNPs (tag SNPs) from the haplotype blocks, it becomes possible to estimate genotypes of SNPs (target SNPs) which are highly correlated with the tag SNPs, with a high probability without experimental genotyping. Imputation is a technique for reducing the number of SNPs mounted on a DNA microarray based on this assumption.

The aforementioned non patent literature 1 discloses an attempt to appropriately select tag SNPs having high linkage probability with target SNPs, from tag SNPs candidates by using the association with the target SNPs.

In the current situation, however, more than one million nucleic acid probes have to be mounted on the DNA microarray to detect SNPs with high estimation accuracy, thus resulting in high costs. On the other hand, if the mounted nucleic acid probes are less than one million, the estimation accuracy is reduced and it becomes difficult to provide accurate predictability of diseases and the like based on the SNPs.

An object of the present invention is, for performing imputation of SNPs, to find a means for more appropriately selecting tag SNPs which are contained in the nucleic acid probes and used for performing imputation, the nucleic acid probes being used in a DNA microarray and the like for detecting SNPs.

### Solution to Problem

The present inventors have made a study on use of “mutual information” as an index for appropriately selecting tag SNPs, the mutual information being used in prediction of a secondary structure of RNA, image positioning in a diagnostic imaging processing, and the like, and, to their surprise, found that the use of mutual information can significantly reduce the number of nucleic acid probes corresponding to tag SNPs, the nucleic acid probes being used in a DNA microarray and the like for detecting SNPs, and that performing imputation based on a result obtained by the DNA microarray and the like can maintain accuracy equal to or higher than that obtained by an existing commercial DNA microarray and the like. The present invention has been completed on the basis of these findings. It is noted that, as described above, in the present invention, the term “SNP(s)” is an abbreviation of single nucleotide polymorphism(s) and covers both the singular and the plural, as is the case for “nucleic acid probe(s)”. The term “group” in a “group of SNPs” and a “group of nucleic acid probes” conventionally refers to a large number of SNPs and nucleic acid probes, however, strictly speaking, it refers to a plurality of, that is, two or more, SNPs and nucleic acid probes. Further, the term “nucleic acid probe corresponding to a tag SNP” refers to a nucleic acid probe for identifying the tag SNP and is specifically disclosed in a section of “array of the present invention” in an item (3) of DESCRIPTION OF EMBODIMENTS.

The present invention provides the following.

Firstly, the present invention provides a selection method of tag SNPs (hereinafter also referred to as a selection method of the present invention), for constituting a group of nucleic acid probes corresponding to the tag SNPs, the tag SNPs being used for performing imputation of information on SNPs of human genome by using human genome information, the human genome information including information on a group of SNPs, the genotypes of the SNPs being identified in multiple individuals, the method comprising:

a) a step of using, as a population, the group of SNPs in the human genome information, and calculating a sum of mutual informations between each SNP of tag SNP candidates and target SNPs, the target SNPs being SNPs positioned in the vicinity which is defined within a prescribed range from the gene locus of the SNP, the tag SNP candidates and target SNPs being included in the group of SNPs; and

b) a step of selecting, from all the tag SNP candidates, the tag SNP candidates having larger sum of the mutual informations in the decreasing order of the sum, as tag SNPs to be included in the nucleic acid probes and used for imputation.

Secondly, the present invention provides a DNA microarray (also referred to as an array of the present invention), comprising the nucleic acid probes corresponding to the tag SNPs selected according to the selection method of the present invention. The array of the present invention can be produced by a production method of DNA microarray (hereinafter also referred to as a production method of array of the preset invention) comprising following steps (1) and (2):

(1) a first step of selecting the tag SNPs according to the selection method of the present invention; and

(2) a second step of mounting on a DNA microarray the nucleic acid probes for detecting genotypes of the tag SNPs of human genome in a specimen, based on the tag SNPs selected in the first step.

Thirdly, the present invention provides a computer system (hereinafter also referred to as a computer system of the present invention) below. That is, the computer system of the present invention is a computer system for selecting tag SNPs, for constituting a group of nucleic acid probes corresponding to the tag SNPs, the tag SNPs being used for performing imputation of information on SNPs of human genome by using human genome information, the human genome information including information on a group of SNPs, the genotypes of the SNPs being identified in multiple individuals, the computer system comprising a recording unit and an arithmetic processing unit, wherein:
(A) the recording unit records at least following information (1) to (4), which are read out from the human genome information and represent information on tag SNP candidates and information on target SNPs, the target SNPs being SNPs positioned in vicinity which is defined within a prescribed range from the gene loci of the tag SNP candidates:
   (1) gene loci of the tag SNP candidates on human genome;
   (2) genotypes of the tag SNP candidates in the individual human genome information;
   (3) gene loci of the target SNPs on human genome; and
   (4) genotypes of the target SNPs in the individual human genome information,
(B) the arithmetic processing unit calculates a sum of mutual informations between the tag SNP candidates and the corresponding target SNPs for each tag SNP candidate based on the information (1) to (4) in (A) obtained from the recording unit, and selects the tag SNP candidate having the maximum sum among the tag SNP candidates as a first tag SNP;
(C) the step of (B) is repeated to select the tag SNP candidate having the maximum sum of the mutual informations as a second tag SNP based on the information on tag SNPs and the information on target SNPs, from which information on the tag SNP that has been already selected and the corresponding group of target SNPs is removed; and
(D) the steps of (B) and (C) are repeated remaining M minus 2 (M−2) times to select an Mth is a natural number) tag SNP until a value of the natural number M reaches a determined intended number of the nucleic acid probes corresponding to the selected tag SNPs, the selected tag SNPs being used for imputation.

The “computer system” herein is categorized as an “object” and can be also considered as a “device”.

Fourthly, the present invention provides a computer program (hereinafter also referred to as a program of the present invention) below. That is, the program of the present invention is a computer program for selecting tag SNPs, for constituting a group of nucleic acid probes corresponding to the tag SNPs, the tag SNPs being used for performing imputation of information on SNPs of human genome by using human genome information, the human genome information including information on a group of SNPs, the genotypes of the SNPs being identified in multiple individuals, the program comprising an algorithm that allows a computer to realize:
(A) a first function in which following information (1) to (4) are read out from a recording unit to be processed by an arithmetic processing unit, the information (1) to (4) being read out from the human genome information to be recorded in the recording unit and representing information on the tag SNP candidates and information on target SNPs, the target SNPs being SNPs positioned in the vicinity which is defined within a prescribed range from a gene locus of each of the tag SNP candidates:
   (1) gene loci of the tag SNP candidates on human genome;
   (2) genotypes of the tag SNP candidates in the individual human genome information;
   (3) gene loci of the target SNPs on human genome; and
   (4) genotypes of the target SNPs in the individual human genome information;
   (B) a second function in which a sum of mutual informations between the tag SNP candidates and the corresponding target SNPs is calculated for each tag SNP candidate based on the information (1) to (4) read out by the first function, and the tag SNP candidate having the maximum sum is selected as a first tag SNP among the tag SNP candidates; and
   (C) a third function in which the tag SNP candidate having the maximum sum of the mutual informations is selected as a second tag SNP by the second function based on the information on tag SNPs and the information on target SNPs, from which information on the tag SNP which has been already selected and the corresponding group of target SNPs is removed, and then the steps of (B) and (C) are repeated remaining M minus 2 times to select an Mth (M is a natural number) tag SNP until a value of the natural number M reaches a determined intended number of the nucleic acid probes corresponding to the selected tag SNPs, the selected tag SNPs being used for performing imputation.

The present invention further provides a computer readable recording medium (hereinafter also referred to as a recording medium of the present invention) in which the program of the present invention is recorded. The computer system of the present invention is typically executing the program of the present invention.

(I) In the selection method and the computer system of the present invention, a “group of target SNPs used for calculating a sum of mutual informations for each tag SNP candidate” is preferably pre-selected by an index other than the mutual information from the viewpoint of selection efficiency. From the similar viewpoint, the program of the present invention preferably comprises, in a pre-stage of the algorithm for realizing the second function described above, an algorithm for realizing preliminary selection of the group of target SNPs subjected to the second function by selecting the group of target SNPs by an index other than the mutual information.

The term the “index other than the mutual information” herein is typically a linkage disequilibrium value, such as an r² linkage disequilibrium value or a d linkage disequilibrium value, between a tag SNP candidate and target SNPs positioned in vicinity which is defined within a prescribed range from a gene locus of the tag SNP. For the purpose of selecting the tag SNPs, it is preferred that SNPs of which the linkage disequilibrium values are smaller than specific threshold values are excluded and the remaining SNPs are used as the target SNPs for calculating the mutual informations to select the tag SNPs. As the “index other than the mutual information” described above, the “r² linkage disequilibrium value” is preferably used. When the “r² linkage disequilibrium value” is used, a threshold value is preferably in a range of 0.70 to 0.85. When the threshold value exceeds 0.85, the pre-selection becomes too strict, thereby increasing a risk of excluding the originally suitable tag SNP candidates from the selection. On the other hand, when the threshold value is less than 0.70, there are too many target SNPs to be used for calculating the sum of the mutual informations. The pre-selection is too loose and thus the selection step tends to become inefficient.

(II) In the present invention (the selection method, the computer system, and the program), the “vicinity which is defined within a prescribed range” from the gene locus of a tag SNP candidates is a region preferably within 500 kbps, further preferably within 100 to 500 kbps, from the gene locus of the tag SNP toward the upstream and downstream sides.

(III) In the present invention (the selection method, the computer system, and the program), the “number of the tag SNPs to be selected” is the number of the tag SNPs which are selected for constituting the nucleic acid probes and used for imputation, and needs to be a number or more, a result of the imputation performed by the number of the tag SNPs satisfying specified performance. An index determining the “specified performance” is not particularly limited, but it is preferably an index that can more objectively reflect the performance of the imputation performed by the means using the tag SNP information.

As a preferable example of the index, the number of the tag SNPs is a number or more, the number leading to a result that an average square value of correlation coefficients between genotypes of SNPs having a minor allele frequency (MAF) of 5°/a or more, determined by typing through an experiment, and their genotypes estimated by the imputation is 0.94 or more, preferably 0.95 or more, more preferably 0.96 or more. When the number of the tag SNPs is less than that, it is unclear if correlation between the genotypes obtained by the imputation based on typing results of the selected tag SNPs and their actual genotypes is superior to that of conventional products, thus making it difficult to sufficiently exhibit expected advantageous effects of the present invention over the conventional products. Additionally, the following indexes may be used: an average square value of correlation coefficients between genotypes of SNPs having the MAF of 3 to 5%, estimated by the imputation, and their actual genotypes is 0.82 or more, preferably 0.84 or more, more preferably 0.87 or more; and an average square value of correlation coefficients between genotypes of SNPs having the MAF of 1 to 3%, estimated by the imputation, and their actual genotypes is 0.73 or more, preferably 0.75 or more, more preferably 0.79 or more.

An upper limit of the number of the tag SNPs is not particularly limited, but it is one million or less at the time when the present invention is completed. Further, it is preferably 700,000 or less from the viewpoint of both economic efficiency and reliability of SNP prediction caused by the number in use. It is noted that a specific lower limit of the number is approximately 300,000 as a rough indication. As shown in Examples below, it has been demonstrated that excellent imputation exceeding basic criteria based on the MAF described above can be performed with the number of 300,000. Further, it is assumed that the number is preferably approximately 400,000 or more, more preferably approximately 500,000 or more, extremely preferably approximately 600,000 or more. The number can be appropriately selected by referring to the indexes based on the MAF described above, and the like, according to the expected performance of the array of the present invention. The inventors actually performed identification of the tag SNPs of 675,000 or less in Japanese individuals, and disclosed the results in the description of Japanese Patent Application No. 2014-223834.

The term “approximately” representing the number of SNPs, such as “approximately 300,000 and approximately 400,000”, in the above description, has the same meaning as “about” and particularly implies that the performance of the imputation with a particular number of the tag SNPs, for example, “the tag SNPs of 300,000”, is not substantially changed by having fluctuations in the number within a certain range. Specifically, the performance of the imputation is not substantially changed when the particular number of the tag SNPs fluctuates within 1%, or, in a strict sense, within 0.5%. This provides a guide value when some of SNPs need to be removed from the group of tag SNPs that has been selected. Further, if the SNPs to be removed from the tag SNPs that has been selected do not actually contribute to the imputation, removing such SNPs has a further minor effect on the performance of the imputation.

It is anticipated that, in the group of tag SNPs selected according to the selection method of the present invention, a small number of tag SNPs are not really detected as SNPs in a population to which the present invention is applied and thus do not exhibit the proper performance of the imputation when the nucleic acid probes corresponding to these SNPs are actually synthesized and mounted on a DNA microarray. Although such SNPs are revealed mainly by a follow-up verification, the nonfunctional SNPs can be further removed from the group of tag SNPs to be used. Since the number of the SNPs to be removed by this reason is a relatively very small number (approximately 0.1% at most), removal of such SNPs can be performed well within the aforementioned range in which “the performance of the imputation is not substantially changed”. In other words, when the particular number of the tag SNPs is selected according to the selection method of the present invention, the particular number is allowed to include a number of the SNPs to be removed, the number being equivalent to the ratio (%) described above.

(Iv) The “human genome information” used in the selection method and for executing the computer system of the present invention may be based on information on human genome database, for example, database for the international 1000 genomes project in all humankind. However, the accuracy of estimation of SNPs based on the tag SNPs tends to increase by using human genome information in a smaller category. Such a category is preferably defined by race such as: Mongoloid in Asia such as, for example, Japanese, Chinese, Malay, Polynesian, Micronesian, and the like; Caucasian such as, for example, Italian, English, Iranian, Indian, Lapps, and the like; Amerind such as, for example, Eskimo, Brazilian Indian, Alaska Indian, and the like; Negroid such as, for example, Nigerian, Bantu people, San; Australoid such as, for example, native Australian, Papua New Guinea people, and the like. A further smaller category may be used. Further, a category may be narrowed down into a particular region and a group of individuals who are affected with particular disorders, so that analysis, prediction, and the like of endemic diseases can be accurately performed. However, it is necessary that specific human genome information is available in any of these categories. In the present Examples, the advantageous effects of the present invention were verified based on database containing 1070 Japanese human genomes provided by the “Tohoku Medical Megabank Organization (ToMMo) at Tohoku University”.

(v) Genotypes detected by the group of nucleic acid probes corresponding to the tag SNPs selected by the present invention (the selection method, the computer system, and the program) are preferably used for performing imputation of information on SNPs of human genome as described above. The “means for detecting genotypes detected by the group of nucleic acid probes corresponding to the tag SNPs” is not particularly limited so long as genotypes of SNPs can be detected, and includes a nucleic acid detection means capable of detecting SNPs, which is currently available or provided in the future. Specific examples of such a means include a DNA microarray, a next-generation sequencer NGS, a Sanger sequencer, and a MassARRAY (registered trademark). Of these, the DNA microarray provided by the array of the present invention is one of optimum means for detecting SNPs at the present.

(VI) The specific production method of the array of the present invention using the nucleic acid probes capable of detecting polymorphism of bases of the tag SNP bases can be performed according to a production method of DNA microarray known at the time of the present invention or a production method of DNA microarray to be provided in the future.

(VII) Addition of Other SNPs

Further, in the present invention, one or more kinds of other SNPs may be selected separately from the selection of the tag SNPs and preferentially incorporated into the tag SNPs, or a means for incorporating such SNPs may be taken.

That is, in the selection method of the present invention, one or more kinds of other SNPs may be selected separately from the selection of the tag SNPs according to the selection method of the present invention and preferentially incorporated into the tag SNPs. A group of nucleic acid probes corresponding to the said other SNPs may be also mounted on the array of the present invention.

Further, the computer system of the present invention may select one or more kinds of other SNPs separately from the selection of the tag SNPs according to the selection method of the present invention, and preferentially incorporate them into the tag SNPs as SNPs to be selected.

Further, the program of the present invention may be provided with an algorithm for realizing that one or more kinds of other SNPs are selected separately from the selection of the tag SNPs according to the selection method of the present invention and preferentially identified as SNPs to be selected. Hereafter, unless otherwise specified, the term “other SNPs” refers to “one or more kinds of other SNPs” described above.

When other SNPs described above are incorporated, duplication between other SNPs and the tag SNP selected by the selection method of the present invention is preferably avoided. A method for removing duplicated SNPs is not particularly limited. For example, the SNPs that are preferentially incorporated are removed in advance from the population of the SNPs used for selecting the tag SNPs, or a means for performing such an operation is taken. Alternatively, SNPs duplicated between the tag SNPs and other SNPs are removed from other SNPs to be incorporated after the tag SNPs are selected, or a means for performing such an operation is taken.

As other SNPs, practically useful SNPs that are hardly selected by the selection method of the present invention can be preferably mentioned. By preferentially using nucleic acid probes identifying these SNPs, a purpose of more clearly characterizing a DNA array, and the like can be achieved.

It is noted that the reason other SNPs are incorporated into the tag SNPs is that detection of other SNPs itself is directly used as indexes of particular disorders and genetic traits, not because other SNPs are used for the imputation. Thus, when the performance of the imputation performed by the group of tag SNPs selected by the selection method of the present invention is evaluated, contribution made by incorporating other SNPs is excluded from such evaluation. Even though there are some duplicated SNPs between other SNPs and the tag SNPs, the number of the duplicated SNPs is relatively small and their contribution is practically negligible in the evaluation of the imputation performance. In Example 4-3 in the description of Japanese Patent Application No. 2014-223834, the imputation performance was evaluated by intentionally including contribution of other SNPs that were incorporated. In this Example, a considerable number (20,000 or more) of other SNPs, which were substantially composed of SNPs other than the tag SNPs, were included in about 650,000 SNPs, and it was confirmed that their impact on the imputation performance was negligible. Specifically 21,059 tag SNPs were removed from the group of tag SNPs consisting of 675,000 SNPs and the same number (21,059) of “other SNPs” was added. The imputation performance was evaluated by intentionally including these “other SNPs”. As a result, average values of r² of SNPs having MAFs of 1 to 3%, 3 to 5%, and 5% or more were 0.804, 0.884, and 0.959, respectively. These numbers were superior to that of an existing commercial DNA array (OMNI2.5) and thus proved the excellent imputation performance.

Examples of the practically useful SNPs as candidates for “other SNPs” include (a) SNPs of which genotypes are hardly estimated with sufficient accuracy by imputation due to the weak linkage disequilibrium with tag SNPs, (b) SNPs derived from Y chromosome and mitochondria, (c) SNPs reported to be associated with diseases by previous research, (d) SNPs derived from HLA region, and (e) SNPs reported to be associated with drug metabolism. These examples are described further in detail below.

(a) SNPs of which genotypes are hardly estimated with sufficient accuracy by imputation due to the weak linkage disequilibrium with tag SNPs:

Other SNPs in this category include tag SNPs having low r² linkage disequilibrium values (e.g., r²<0.2) with the tag SNPs of the present invention. Of these, selection of such SNPs as affecting amino acid sequences of proteins is practically preferable.

(b) SNPs derived from Y chromosome and mitochondria:

Regarding other SNPs in this category, selection of the tag SNPs according to the r² linkage disequilibrium value has no effect since genetic recombination does not occur in a region of Y chromosome. The number of these SNPs is small, thus it is relatively easy to select all of these SNPs from the target SNPs regardless of their r² linkage disequilibrium values.

(c) SNPs reported to be associated with diseases by previous research:

Other SNPs in this category are available in database, NHGRI GWAS Catalog (http://www.genome.gov/gwastudies/: Welter, D. et al. The NHGRI GWAS Catalog, a curated resource of SNP-trait associations. Nucleic Acids Res. 42, D1001-6 (2014)).

(d) SNPs derived from HLA region:

Regarding other SNPs in this category, the HLA region is a region whose association with diseases has been reported in many cases. Thus, it is practically preferable to select these SNPs from the tag SNPs regardless of their r² linkage disequilibrium values.

(e) SNPs reported to be associated with drug metabolism:

Other SNPs in this category have been studied using Affymetrix® DMET™ plus (Affymetrix, Inc.) and the results are published in the following documents. The SNPs published in these documents may be used as other SNPs.

[Technology Reviews]
Burmester J. K., et al. DMET microarray technology for pharmacogenomics-based personalized medicine. Methods in Molecular Biology 632: 99-124 (2010).
Sissung T. M., et al. Clinical pharmacology and pharmacogenetics in a genomicsera: the DMET platform. Pharmacogenomics 11(1): 89-103 (2010).
Deeken J. F. The Affymetrix DMET platform and pharmacogenetics in drug development. Current Opinion in Molecular Therapeutics 11(3): 260-268 (2009).

[Identification of New Drug-Related Biomarkers]
Caldwell M. D., et al. CYP4F2 genetic variant alters required warfarin dose. Blood 111(8): 4106-12 (2008).
McDonald M. G., et al. CYP4F2 Is a vitamin K1 hydroxylase: A molecular explanation for altered warfarin dose in carriers of the functionally defective V433M variant. 15th North American Regional ISSX meeting Abstract 67 (2008).

[Drug Development and Safety Research]
Mega J. L., et al. Cytochrome p-450 polymorphisms and response to clopidogrel. New England Journal of Medicine 360(4): 354-62 (2009).
U.S. Food and Drug Administration. Early communication about an ongoing safety review of clopidogrel bisulfate (marketed as Plavix).
Dumaual C., et al. Comprehensive assessment of metabolic enzyme and transporter genes using the Affymetrix Targeted Genotyping System. Pharmacogenomics 8(3): 293-305 (2007).
Daly T. M., et al. Multiplex assay for comprehensive genotyping of genes involved in drug metabolism, excretion, and transport. Clinical Chemistry 53(7): 1222-30 (2007).

[Genotype/Phenotype Databasing]
Man M., et al. Genetic variation in metabolizing enzyme and transporter genes: Comprehensive assessment in 3 major East Asian subpopulations with comparison to Caucasians and Africans. Journal of Clinical Pharmacology doi: 10.1177/0091270009355161 (2010).
UNC's McCleod discusses ‘practical’ approach to bringing pharmacogenetics to all countries. GenomeWeb Pharmacogenomics Reporter (2010).

### Advantageous Effects of Invention

The present invention provides a means for performing imputation in a DNA microarray and the like for detection of SNPs, in which the number of tag SNPs used in the imputation can be significantly reduced and performance of the imputation based on results obtained by said means can is maintained with accuracy equal to or higher than that of an existing commercial DNA microarray and the like, a DNA microarray produced by said means, and a production method of the DNA microarray. More specifically, the present invention makes it possible to select nucleic acid probes for detecting SNPs at a low cost based on the significant reduction of the number of the tag SNPs and the excellent imputation performance described above, thus enabling to provide a cost-effective service of genetic information. Further, an array detection unit required to exhibit the excellent imputation performance can be made compact by significantly reducing the number of the nucleic acid probes. These features are expected to greatly contribute to an improvement of performance of future gene analysis technologies. Furthermore, although Examples described below disclose results obtained from Japanese individuals as a population, the present invention can be basically applied to any race as a population and also to the imputation involving different races.

### BRIEF DESCRIPTION OF DRAWINGS

FIG. 1 is a flowchart outlining contents of a program of the present invention.

FIG. 2 is a flowchart in which the flowchart in FIG. 1 is more specifically described.

### DESCRIPTION OF EMBODIMENTS

An object of the present invention is, as described above, to select a group of tag SNPs capable of significantly reducing the number of tag SNPs which are used for performing imputation using a DNA microarray and the like for detecting SNPs and correspond to nucleic acid probes mounted on the array, and keeping imputation performance based on results obtained by said tag SNPs with accuracy equal to or higher than that of an existing commercial DNA microarray and the like, and to prepare a DNA microarray mounted with nucleic acid probes corresponding to the selected tag SNPs. This object can be achieved according to a selection method of the present invention described above. The selection method of the present invention can be performed preferably by executing a program of the present invention in a computer system of the present invention.

(1) Selection Method of Present Invention

In the “human genome information including information on a group of SNPs, the genotypes of the SNPs being identified in multiple individuals” in the selection method of the present invention, identifying the group of SNPs can be performed by applying a known statistical processing to multiple human genome nucleotide sequences obtained by a next-generation sequencer (NGS) and the like.

Further, in order to obtain a “mutual information” and a linkage disequilibrium value such as an “r² linkage disequilibrium value”, as an index of the selection method of the present invention, frequencies of genotypes of the tag SNPs and target SNPs need to be calculated from the “gene loci and genotypes of individual SNPs on human genome” described above. Such frequencies can be obtained by a routine procedure. When haplotypes of the group of SNPs are identified, the linkage disequilibrium values and the mutual informations of the group of SNPs can be calculated more precisely, thus it is preferable. In such a case, the frequency of a genotype as described above can be considered as the frequency of the alleles constituting the genotype, and the frequency of combination of the genotypes between two SNPs can be considered as the frequency of the identified haplotype. Further, a means for identifying haplotypes is a known “phasing processing”.

Methods of the phasing processing are roughly classified into two as described below.

(A) Method using linkage disequilibrium between separated loci (polymorphic loci) (SHAPEIT2; Delaneau et al., Improved whole chromosome phasing for disease and population genetic studies, Nature Methods, 2013; MaCH: Li et al., MaCH: using sequence and genotype data to estimate haplotypes and unobserved genotypes, Genetic Epidemiology, 2010)

In this method, a phasing is statistically performed using genotype data normally from a group of 1,000 or more individuals. This method detects mutation loci having high allele frequencies (5% or more) with high accuracy, however its accuracy tends to be decreased with loci having low allele frequencies due to an insufficient number of data. Thus, the method requires genotypes from a sample group containing a vast number of individuals to achieve high accuracy.

(B) Method using read information by sequencer (GATK Read Backed Phasing (developed by Broad Institute); HapCompass: Aguiar D., and Istrail S., Hapcompass: a fast cycle basis algorithm for accurate haplotype assembly of sequence data, Journal of Computational Biology, 2012)

In this method, when reads obtained by a sequencer encompass adjacent heterozygous loci, the phasing is performed by examining bases inside the reads. The phasing can be performed in loci having low allele frequencies with this method, however lengths of reads obtained by a sequencer are normally limited to several hundred bps at most. Thus, regions in which the phasing can be performed tend to be limited. However, lengths of reads have been increasing in accordance with technical progresses of a next-generation sequencer.

In the selection method of the present invention,

a) a group of SNPs in the human genome database is used as a population, and in the group of SNPs, a sum of mutual informations between each of tag SNP candidates and corresponding target SNPs is calculated, the corresponding target SNPs being positioned in vicinity which is defined within a prescribed range from the gene locus of each of the tag SNP candidates.

The mutual information is a value defined by a following formula, provided that two random variables x and y conform to probability distributions p(x) and p(y), and a joint probability of x and y conforms to p(x, y).

$$I ( X ; Y ) = {\sum }_{y ∈ Y}^{ } {\sum }_{x ∈ X} p ( x , y ) log \frac{p ( x , y )}{p ( x ) p ( y )} \qquad [ Mathematical 1 ]$$

In the preset invention, x and y represent genotypes of two different SNPs, and p(x) and p(y) represent their respective frequencies. p(x, represents a frequency of observing the genotypes of these two SNPs at the same time. The “mutual information of a tag SNP candidate and a target SNP” can be calculated according to this definition. In other words, as a premise for calculating the mutual information, it is necessary to calculate not only the frequency of the genotype of each of tag SNP candidates, but also the frequency of observing the genotype of a tag SNP candidate and each of the genotypes of the corresponding target SNPs at the same time, the corresponding target SNPs being positioned in vicinity which is defined within a prescribed range from the gene locus of the tag SNP candidate. However, when haplotypes of the group of SNPs are identified, the frequencies of the genotypes can be considered as frequencies of alleles constituting the genotypes, and the frequency of observing the genotypes of two SNPs at the same time can be considered as the frequency of the haplotype.

Sum of the “mutual informations of a tag SNP candidate and the corresponding target SNPs” thus calculated are calculated for each tag SNP candidate to obtain an essential element of the index of the selection method of the present invention.

Then, b) the tag SNP candidates having the large sum of the mutual information are selected from all of the tag SNP candidates in the order form the larger sum as the target SNPs which are included in the nucleic acid probes and used for performing the imputation described above. It is thereby possible to perform the selection method of the present invention.

In the selection method of the present invention, as described above, the group of target SNPs is preferably pre-selected by an index other than the mutual information described above, from the viewpoint of improving efficiency in the selection of the tag SNPs. As such an index, the “r² linkage disequilibrium value (R square value or R̂2)” is particularly preferable. The r² linkage disequilibrium value is a Pearson's correlation coefficient relating to frequencies of genotypes of two SNPs. The value ranges from 0 to 1 and, as the value approaches 1, there is stronger linkage disequilibrium between the genotypes of two SNPs. It is noted that when haplotypes of the group of SNPs are identified, the frequencies of the genotypes can be considered as frequencies of alleles constituting the genotypes, and the frequency of observing the genotypes of two SNPs at the same time can be considered as the frequency of the haplotype.

The selection method of the present invention can be efficiently performed by pre-selecting the group of target SNPs having a certain level or more of the linkage disequilibrium, in regards to the linkage disequilibrium values such as the r² linkage disequilibrium value. The threshold values of the r² linkage disequilibrium value for the selection are described above. Further, the “vicinity which is defined within a prescribed range” and the “number of the tag SNPs to be selected”, as well as the “incorporation of other SNPs” are also described above.

(2) Computer System and Computer Program of Present Invention

The computer system of the present invention is a system that serves as a means for performing the selection method of the present invention, and the program of the present invention is a computer program comprising an algorithm that allows the computer system of the present invention to perform the selection method of the present invention. Similar to a general concept in a computer field, the term “algorithm” refers to a formulated form of procedures for solving problems.

The computer system of the present invention may comprise a hardware used in a conventional computer system. That is, it normally comprises a “recording unit” corresponding to a hard disk drive and an “arithmetic processing unit” corresponding to a CPU, as well as, for example, a “temporary storage unit” corresponding to a RAM, an “operation unit” corresponding to a keyboard, a mouse, a touch panel, and the like, a “display unit” corresponding to a display, an “input/output interface (IF) unit” corresponding to a serial or parallel interface, or the like according to the operation unit, and a “communication interface (IF) unit” having a video memory and a D/A converter and outputting an analog signal according to a video system of the display unit. The communication IF unit is configured to exchange data with external information, in particular, human genome information such as human genome database.

Hereafter, unless otherwise specified, the description is provided on a processing performed by the “arithmetic processing unit” of the computer system of the present invention. The “arithmetic processing unit” obtains data of, in particular, human genome database via the “communication IF unit” by the operation of the “operation unit”, records the data in the “recording unit”, reads out the data from the “recording unit” to the “temporary storage unit”, performs prescribed processings on the data, and then records results of the processings to the “recording unit” again. The “arithmetic processing unit” creates screen data for prompting an operator to operate the “operation unit” and screen data for displaying the processing results, and displays these images on the “display unit” via a video RAM of the input IF unit. The program of the present invention is recorded when it is required or in advance in the “recording unit” or in an external hardware resource and, according to an algorithm written in the program, necessary arithmetic processings are performed in the “arithmetic processing unit”.

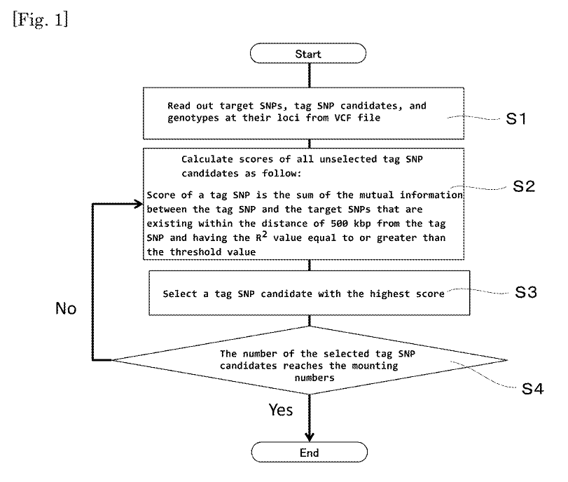

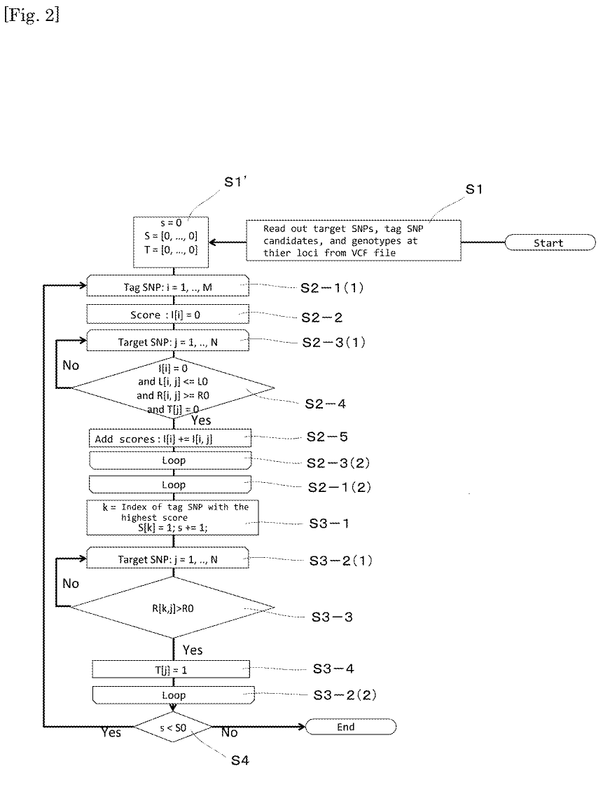

FIG. 1 shows a flowchart outlining contents of the program of the present invention, and FIG. 2 shows a flowchart in which the flowchart in FIG. 1 is more specifically described. A step S1 is common between FIG. 1 and FIG. 2 and corresponds to a step of “reading out target SNPs, tag SNP candidates, and genotypes of their gene loci from an input file containing information on the site (chromosome and position) of each SNP and individual genotypes”. In Examples described below, a file which is an example of human genome information and comprises information of chromosome sites where mutations are found in a reference panel is used as the input file. The reference panel is a data file of full length genome sequences from 1070 Japanese individuals, which have been determined using a next generation sequencer (NGS) by the Tohoku Medical Megabank Organization (ToMMo).

The step S1 describes a first function of the program of the present invention. Specifically, the step S1 describes the “first function” of reading out following information (a) to (d) from the recording unit to be processed in the arithmetic processing unit, the information (a) to (d) being obtained from human genome information containing genotypes of multiple individuals and recorded in the recording unit:

(a) a gene locus of each of the tag SNP candidates on human genome;

(b) genotypes of the tag SNP candidates in individual human genome information;

(c) gene loci of the target SNPs on human genome; and

(d) genotypes of the target SNPs in individual human genome information.

As described above, a step of preferentially incorporating “other SNPs” may be provided as a pre-step of the step S1. In such a case, a step of removing other SNPs from the tag SNP candidates is preferably provided. It is preferred that the step of pre-incorporation is alternatively provided with a step of post-incorporation described below.

A step S1′ in FIG. 2 shows initial setting states of the tag SNPs and the target SNPs to be selected in a later step. In the step S1′, “s” represents the number of the selected tag SNPs and is currently set as “s=0”, indicating that no tag SNP is selected. In this context, “S=[0, . . . , 0]” indicates that no tag SNP candidate is selected at all (the number of 0s in a row [ ] represents the number of SNPs to be examined. Becoming 1 from 0 indicates that an SNP represented by the position of 1 is selected as the tag SNP candidates). The state of the “target SNPs” are represented by “T=[0, . . . , 0]” in the same manner as the “tag SNP candidate” described above.

A step S2 in FIG. 1 is a step of “calculating scores of all unselected tag SNP candidates” using the human genome information read out from the recoding unit in the step S1. The step S2 describes the first half of a second function of the program of the present invention. Steps S2-1(1), S2-2, S2-3(1), S2-4, S2-5, S2-3(2), and S2-1(2) in FIG. 2 correspond to the step S2 in FIG. 1. These steps are collectively described as the “step S2”. It is noted that the steps S2-1(1)42) and the steps 2-3(1)/(2) constitute a pair of loop ends, respectively.

The step S2 describes a function of calculating a sum of mutual informations between each of the tag SNP candidates and the corresponding target SNPs based on the information (1) to (4) read out by the first function, and scoring the sum for each tag SNP candidate. The mutual information is information concept calculated by the previously described numerical calculation. As a premise for calculating the mutual information, it is necessary to calculate not only the frequency of the genotype of each of tag SNP candidates, but also the frequency of the combination of the genotype of a tag SNP candidate and each of the genotypes of the corresponding target SNPs, the corresponding target SNPs being positioned in vicinity which is defined within a prescribed range from the gene locus of the tag SNP candidate. Such frequency calculation is preferably performed in the step S2.

Further, in the present example, a preferred embodiment is shown. In the preferred embodiment, the selection of the target SNPs which are used for calculating the mutual information with each of the tag SNPs, is performed by using a threshold value defining a lower limit of the r² linkage disequilibrium value (R̂2). The calculation method of the r² linkage disequilibrium value and the preferable range of the threshold value are described above. In Examples below, the threshold was set as “r²>0.8”.

The step S2-1(1) shown in FIG. 2 is a starting end of the loop in which one tag SNP candidate “i” among M tag SNP candidates is selected in each repeat. A “score: =0” in the step S2-2 indicates initialization of the tag SNP candidate “i” selected in the step S2-1(1) at this time point. The step S2-3(1) is a starting end of the loop in which one target SNP “j” among N target SNPs is selected in each repeat.

The step S2-4 is a step of determining if score calculation is performed or not. In a combination of the tag SNP candidate “i”, and the target SNP “j” paired therewith to be examined, “L[i, j]<=L0” indicates that a distance “L0” (bps) on the genome between the tag SNP candidate “i” and the target SNP “j” is a specific value or less. That is, “L0” represents a distance within the vicinity which is defined within a prescribed range from the gene locus of the tag SNP candidate. Such a distance is described above. Further, “R[i, j]>=R0” indicates that the r² linkage disequilibrium value between the tag SNP candidate “i” and the target SNP “j” is a threshold value “R0 or more”. Such a threshold value is also described above. T[j] is set to 1 when the examined target SNP “j” is already covered by one or more tag SNP candidate and set to 0 when it is not the case. That is, a state of T[j]=0 indicates that the selected target SNP “j” is not covered by the tag SNP candidate “i” forming a pair therewith. The step 2-4 describes a step of determining whether or not conditions in a condition box are met, in which if “YES” is selected, the next step S2-5 is started, and if “No” is selected, the step S2-3(1) is repeated.

The step S2-5 is a step of calculating a score and adding the scored value to the tag SNP candidate “i”, when the decision in step S2-4 is “Yes”. As described above, the “score” refers to the mutual information between the tag SNP candidate “i” and the target SNP “j” forming a pair therewith and covered thereby.

The step S2-3(2) is an end of the loop of the step S2-3(1) in which the target SNPs are selected, as described above, while the step S2-1(2) is an end of the loop of the step S2-1(1) in which the tag SNP candidates are selected, as described above. A pair of the tag SNP candidate and the target SNP to be examined is renewed by these loops.

The step S3 shown in FIG. 1 is a step of “selecting one tag SNP candidate having the maximum score calculated in the step S2”. The step S2 describes the second half of the second function of the program of the present invention and corresponds to the steps S3-1, S3-2(1), S3-3, and S3-2(2) in FIG. 2. The steps S3-2(1)/(2) constitute a pair of loop ends.

The step S3-1 is a step in which the tag SNP candidate having the maximum score calculated in the step S2 is assigned with the number “k” as the tag SNPs to be selected, and one of 0s in the row of the S value described above is converted to “1”. The step S3-2(1) is a starting end of the loop to record that all of the target SNPs (j=1, . . . , N) corresponding to the tag SNP “k” having the maximum score are covered by the tag SNP “k”. The step S3-3 is a step for determining if an update to T[j]=1 in the next step S3-4 is performed or not. Specifically, when the r² linkage disequilibrium value between the tag SNP “k” having the maximum score at the present time point and the target SNP “j”, one of SNPs in the group of target SNPs corresponding to the tag SNP “k”, is the threshold value “R0 or more”, it is determined as “yes” and then the next step S3-4 is started to confirm that the target SNP “j” is already covered as the target SNPs of the tag SNP “k”, to perform an update to T[j]=1. Next, the step 3-2(1) described above is repeated again from the step S3-2(2), an end of the loop of the step 3-2(1), to examine the next target SNP. This loop is completed when all of the target SNPs in the group of target SNPs described above are examined, and then the next step S4 is started. On the other hand, when the r² linkage disequilibrium value of the target SNP “j” is “less than R0” of the threshold value, it is determined as “No” in the step S3-3, and then the step S3-2(1) is repeated without recording the target SNP “j” as covered, to examine the next target SNP in the same manner.

The step S4 is common between FIG. 1 and FIG. 2, and a step of “determining whether or not the total number of the selected tag SNP candidates reaches an intended number”. In FIG. 2, the number of SNPs to be mounted is set to “S0”. The step S4 describes a third function of the program of the present invention. Specifically, the step S4 describes the third function in which the tag SNP having the maximum sum of the mutual informations (as described above, the pre-selection using the threshold value of the r² linkage disequilibrium values is performed in the present example) is selected again as a second tag SNP by repeating the steps S2 and S3 based on the tag SNP information and the target SNP information, from which information on a group of target SNPs selected in the steps S2 and S3 performing the second function is removed. In the third function, this repeating step in which the steps S2 and S3 are repeated is performed until an “intended number in a means for performing imputation such as a DNA microarray and the like for detecting SNPs” is reached.

As described above, after the step S4, a step of preferentially incorporating “other SNPs” may be provided. In such a case, a step of removing the aforementioned tag SNPs that have been already selected, from the other SNPs is preferably provided. It is preferred that the step of post-incorporation is alternatively provided with the step of pre-incorporation described above.

The program of the present invention may be written in a programming language such as C, Java (registered trademark), Perl, and Python and run in multi-platforms.

Further, the program of the present invention may be stored in a computer-readable storage medium or a storage medium that can be connected to a computer. These storage media can be also provided as the storage medium of the present invention. Examples of these storage media include magnetic media such as a flexible disk, a flash memory, and a hard disk, optical media such as a CD, a DVD and a BD, magneto-optic media such as an MO and an MD. However, the present invention is not particularly limited thereto.

(3) Array of Present Invention

The array of the present invention can be produced by selecting the tag SNPs using the selection method or the computer system of the present invention described above (first step) and mounting nucleic acid probes corresponding to information on the selected tag SNPs (second step). Specifically, the array of the present invention can be produced by: (a) a first step of selecting the tag SNPs according to the selection method of the present invention; and (b) a second step of mounting on a DNA microarray the nucleic acid probes for detecting genotypes of the tag SNPs in the human genome in a specimen, based on the tag SNPs selected in the first step. The second step may be performed by a commonly used known method. Further, a new DNA microarray production method to be provided in the future may also be used so long as advantageous effects of the present invention are not impaired.

In the preparation of the nucleic acid probes, DNA fragments serving as sources of probes can be obtained, for example, by gene amplification methods such as a PCR method and an RNA PCR (RT-PCR) method, where appropriate amplification primers are used to amplify nucleotide sequences of human genome containing desired SNP bases, chemical synthesis methods of DNA, and the like. A base length of the DNA fragment is not particularly limited, but it is 10 to 100 bases, further preferably 10 to 40 bases. As the DNA fragment has a longer base length, the probe has higher capturing ability of target nucleotides containing SNP bases, however it becomes unsuitable for a high density DNA microarray. On the other hand, when the DNA fragment has a shorter base length, it is likely that the probe has less capturing ability of target nucleotides. By taking these advantages and disadvantages into account, the base length of the nucleic acid probes to be mounted on the DNA microarray can be designed to produce the nucleic acid probes. For the use as the nucleic acid probes, the DNA fragment described above may be modified by a known method. For the modification of DNA fragment, a commonly used agent in this field, such as various kinds of fluorescent dyes and coloring dyes, may be appropriately used. However, the agent for modification is not limited thereto.

As described above, there is prepared the nucleic acid probes capable of capturing, as a target, the tag SNPs selected based on the preset invention by contact with a DNA sample derived from a specimen and generating a capturing signal on the DNA microarray.

The DNA microarray on which desired nucleic acid probes are mounted can be produced by attaching and fixing the nucleic acid probes previously prepared in this manner on a carrier. Examples of the carrier include glass, plastic (e.g., polypropylene, nylon, and the like), polyacrylamide, nitrocellulose, gel, and other solid phase carriers made of porous materials, non-porous materials, or the like.

As the attaching method of the nucleic acid probes on a surface of the carrier, for example, a printing method on a plate can be mentioned. Further, examples of a method for producing a high density array include a technique in which an array containing thousands of oligonucleotides complementary to specific sequences located at specific locations on a surface is produced in situ by using a photolithography synthetic technique and a method in which DNA strands designed in advance are quickly synthesized and directly attached to the carrier. Further, the DNA microarray can be produced using a masking technique. Further, the DNA microarray can be produced using an inkjet printer for oligonucleotide synthesis. It is also possible to produce the DNA microarray using fluorescent beads and magnetic beads.

By using these methods, the DNA microarray capable of detecting the tag SNPs selected by the present invention can be produced. The DNA microarray can be prepared in-house or obtained, for example, as a “commercially available product” from companies which manufacture microarray upon request.

The array of the present invention thus produced can detect base substitutions in the tag SNPs selected by the present invention in a DNA specimen through contact with the DNA specimen, as individual spot signals, thereby enabling to determine the genotypes of SNPs including whether they are homozygous or heterozygous. The results thus obtained are consolidated and arranged to perform imputation, thereby enabling to estimate information on the target SNPs other than the tag SNPs, which are not mounted on the DNA microarray. The information thus obtained can be used for health management and the like of subjects. The DNA specimen to be used is not particularly limited, so long as a minute quantity of human genome DNA is obtained. Examples of the DNA specimen include blood, saliva, urine, feces, sweat, nail, hair, skin, oral tissue, semen, spinal fluid, and lymph. The DNA specimen can be obtained by purifying genomic DNA from the original specimens as mentioned above.

### EXAMPLES

The present invention will be described by way of Examples below.

### [Example 1] Selection of Tag SNP

As described above, tag SNPs that should be included in nucleic acid probes to be mounted on a DNA microarray were selected by executing a computer program of which contents were shown in FIG. 1 to a file comprising information on chromosome sites where mutations are found in a data file of whole-genome sequences from 1070 Japanese individuals. The whole-genome sequences from 1070 Japanese individuals were determined using a next generation sequencer (NGS) by the Tohoku Medical Megabank Organization (ToMMo).

In this example, the selection method of present invention was performed in the following conditions: a threshold value of an “r² linkage disequilibrium value” used for pre-selection of tag SNP candidates was “r²>0.8”; and a “vicinity which is defined within a prescribed range” was set to ±500 kbps from gene loci of the tag SNP candidates. The number of the tag SNPs used for nucleic acid probes to be mounted on a DNA microarray was 675,000. In this example, the tag SNP candidates and the target SNPs were selected in advance from a group of SNPs consisting of about 9,400,000 SNPs, which had been proven to be successful in analysis of DNA microarray manufactured by Affymetrix, Inc., however such pre-selection is not necessarily performed. For example, the selection method of the present invention may be performed by randomly choosing a group of tag SNPs and a group of target SNPs from any group of SNPs. Further, as an efficient means, SNPs having a low MAF may be removed in advance from the tag SNP candidates. Further, the selection method of the present invention may be performed based on an existing list of the tag SNPs, and the like.

In the present example, the group of tag SNPs consisting of 675,000 SNPs (hereinafter, generally abbreviated as 675k), selected as described above, was evaluated for its performance by performing imputation of genotypes of SNPs of 131 Japanese individuals different from 1070 individuals described above. First, gene loci and genotypes of the SNPs in 131 individuals were identified using the NGS, and information on genotypes of gene loci corresponding to the group of tag SNPs consisting of 675k SNPs selected in the present example was extracted from the obtained data. In this process, identifying genotypes corresponding to the group of tag SNPs described above by analysis results of the NGS corresponds to identifying the genotypes using the DNA microarray. Next, genotypes of SNPs of 131 individuals were estimated (imputed) by comparing the genotypes of the group of tag SNPs of 131 individuals with the human genome information from 1070 individuals described above. In order to evaluate estimation results, a square value (r²) of correlation coefficients between the genotypes estimated by the imputation and the genotypes identified by the NGS in 131 individuals was calculated. When the estimated results and the results identified by the experiment (NGS and the like) are perfectly matched in all 131 individuals, a value of r² is 1.0, indicating that true genotypes are perfectly estimated. On the other hand, the value of r² decreases as the number of mismatches between the true genotypes and the estimated genotypes increases in the specimens. An average value of the r² values that were calculated in this manner for evaluating the selection results of the tag SNPs was calculated as an average value for each range of MAF of the SNPs subjected to the estimation. As a result, the average value of r² of the SNPs was 0.81 with MAF of 1 to 3%, 0.88 with MAF of 3 to 5%, and 0.96 with MAF of 5% or more, demonstrating extremely excellent imputation performance.

The group of tag SNPs consisting of 675k SNPs described above is disclosed in Example 4 (Examples 4-1 and 4-2) in the description of Japanese Patent Application No. 2014-223834.

### [Example 2] Comparison with Existing Commercial DNA Microarray (1)

For comparison with above Example, the genotypes of SNPs from the same 131 Japanese individuals as examined in the present example were estimated by imputation using SNPs mounted on an existing commercial DNA microarray. As a result, when the imputation was performed using SNP information provided by Human Omni 2.5-8 (hereinafter, also simply referred to as OMNI2.5) manufactured by Illumina Inc., the average value of r² of the SNPs was 0.80 with MAF of 1 to 3%, 0.87 with MAF of 3 to 5%, and 0.96 with MAF of 5% or more, demonstrating an approximately the same level of imputation performance as the aforementioned Example. However, the mounting number of SNPs on the commercial DNA microarray was about 2.3 millions (2,338,671, to be exact), which exceeded far more than 675k used in Example described above. Therefore, it was demonstrated that performing imputation using the group of tag SNP selected by the method in the aforementioned Example exhibited a significant advantage over a case of using SNPs mounted on the existing commercial DNA microarray, in that genotypes of SNPs can be estimated with extremely high efficiency.

### [Example 3] Comparison with Existing Commercial DNA Microarray (2)

Next, the imputation performance was examined by reducing the mounting number of the SNPs to less than 675k used in the above, specifically, to 300,000 (hereinafter, abbreviated as 300k), 400,000 (hereinafter, abbreviated as 400k), 500,000 (hereinafter, abbreviated as 500k), and 600,000 (hereinafter, abbreviated as 600k), in addition to 675k. The imputation performance was separately examined in the SNPs having MAF of 1 to 3%, 3 to 5%, and 5% or more. The results were shown in Table 1. It is noted that the tag SNPs consisting of “300k” SNPs, “400k” SNPs, “500k” SNPs, “600k” SNPs, and “675k” SNPs, used herein, are specifically disclosed in Examples 4-1, 4-2-1, 4-2-2, 4-2-3, and 4-2-4, respectively, in the description of Japanese Patent Application No. 2014-223834.

TABLE 1

| Number of | | MAF | | |
|---|---|---|---|---|
| probes | | 1-3% | 3-5% | 5%- |
| 300k | r² value | 0.732 | 0.825 | 0.942 |
| | Relative value* | 0.914 | 0.944 | 0.982 |
| 400k | r² value | 0.761 | 0.848 | 0.951 |
| | Relative value* | 0.950 | 0.970 | 0.992 |
| 500k | r² value | 0.778 | 0.863 | 0.949 |
| | Relative value* | 0.971 | 0.987 | 0.990 |
| 600k | r² value | 0.791 | 0.872 | 0.951 |
| | Relative value* | 0.988 | 0.998 | 0.992 |
| 675k | r² value | 0.809 | 0.880 | 0.960 |
| | Relative value* | 1.010 | 1.007 | 1.001 |
| Human | r² value | 0.801 | 0.874 | 0.959 |
| Omni2.5-8 | Relative value* | 1.000 | 1.000 | 1.000 |
| About 2.3 | | | | |
| millions | | | | |

*Relative value when r² value obtained in Human Omni2.5-8 is set to 1

Followings are evident based on the results of Table 1.

1. Based on the relative values in the above Table 1, the DNA microarray mounting 500k or more of probes obtained by the present invention can exhibit the imputation performance equal to or higher than the OMNI2.5.

2. Even when the number of the mounted probes obtained by the present invention is further reduced to 400k, approximately the same level of imputation performance as the OMNI2.5 can be obtained.

3. When the number of the mounted probes obtained by the present invention is further reduced to 300k, although the performance is a little inferior to the OMNI2.5, it is still nearly equal to the OMNI2.5, demonstrating that the DNA microarray maintains its basic performance described above.

From these results, it was demonstrated that when a DNA microarray was designed by mounting the probes obtained by the present invention, the DNA microarray could exhibit approximately the same level of performance as the OMNI2.5 even if the number of the probes to be mounted was reduced to nearly 1/10 of about 2.3 millions of the probes mounted in the OMNI2.5.

### EXPLANATION OF REFERENCE NUMERALS

S1 Step of describing first function of program of present invention
S1′ Step of describing initial setting states of tag SNPs and target SNPs selected in later steps of aforementioned S1
S2 Step of describing first half of second function of program of present invention
S2-1(1) Step of describing function as starting end of first loop in S2
S2-2 Step of describing initialization of tag SNP candidates
S2-3(1) Step of describing function as starting end of second loop in S2
S2-4 Step of describing decision whether or not score calculation is performed
S2-5 Step of describing addition of score for tag SNP in which score calculation is performed
S2-3(2) Step of describing end of loop of aforementioned S2-3(1)
S2-1(2) Step of describing end of loop of aforementioned S2-1(1)
S3 Step of describing selection of one tag SNP candidate having maximum score calculated in S2
S3-1 Step of describing assignment of number to tag SNP candidate having maximum score
S3-2(1) Step of describing function as starting end of loop in S3
S3-3 Step of describing decision whether or not update is performed in next step
S3-4 Step of describing function of performing update
S3-2(2) Step of describing end of loop of aforementioned S3-2(1)
S4 Step of describing decision whether or not number of selected tag SNP candidates reaches intended number

1. A selection method of tag SNPs for constituting a group of nucleic acid probes corresponding to the tag SNPs, the tag SNPs being used for performing imputation of information on SNPs of human genome, by using human genome information which includes information on a group of SNPs of which genotypes are identified in multiple individuals, the method comprising:
a) a step of calculating a sum of mutual informations between each of tag SNP candidates and target SNPs, the tag SNP candidates and the target SNPs being included in the group of SNPs in the human genome information as a population, and the target SNPs being SNPs positioned in the vicinity which is defined within a prescribed range from a gene locus of each of the tag SNP candidates; and
b) a step of selecting the tag SNP candidates having large sums of the mutual informations in the order of the larger sum from all the tag SNP candidates, as the tag SNPs used for the imputation and to be included in the nucleic acid probes.

2. The selection method of tag SNPs according to claim 1,
wherein the human genome information is human genome database information comprising information on a group of SNPs of which genotypes are identified in multiple individuals.

3. The selection method of tag SNPs according to claim 1,
wherein a group of target SNPs used for calculating the sum of mutual informations for each of the tag SNP candidates are pre-selected by an index other than the mutual information.

4. The selection method of tag SNPs according to claim 3,
wherein the index other than the mutual information is a linkage disequilibrium value between each of the tag SNP candidates and the group of target SNPs positioned in vicinity which is defined within a prescribed range from a gene locus of each of the tag SNP candidates.

5. The selection method of tag SNPs according to claim 4,
wherein the linkage disequilibrium value is an r² linkage disequilibrium value.

6. The selection method of tag SNPs according to claim 1,
wherein the vicinity which is defined by within a prescribed range is a region within 500 kbps from a base of each tag SNP toward an upstream and downstream sides.

7. The selection method of tag SNPs according to claim 1,
wherein the number of the tag SNPs which are used for the imputation and are selected for the nucleic acid probes, is a number or more by which a result of the imputation performed by the tag SNPs satisfies specified performance.

8. The selection method of tag SNPs according to claim 7,
wherein the specified performance is a condition in which an average square value of correlation coefficients between genotypes of SNPs having an MAF of 5%, estimated by the imputation, and actual genotypes of the SNPs is 0.94 or higher.

9. The selection method of tag SNPs according to claim 1,
wherein the human genome information is derived from specific race or a group of humans belonging to a category smaller than the race.

10. The selection method of tag SNPs according to claim 1,
wherein, one or more kinds of other SNPs are selected separately from the selection of the tag SNPs performed by the selection method, and are preferentially incorporated into the tag SNPs.

11. The selection method of tag SNPs according to claim 1,
wherein the group of nucleic acid probes is a group of nucleic acid probes to be mounted on a DNA microarray.

12. A DNA microarray comprising nucleic acid probes corresponding to tag SNPs selected by the selection method of tag SNPs according to claim 1.

13. A production method of a DNA microarray comprising:
(1) a first step of selecting tag SNPs by the selection method according to claim 1; and
(2) a second step of mounting on a DNA microarray nucleic acid probes for detecting genotypes of the tag SNPs of human genome in a specimen based on the tag SNPs selected in the first step.

14. A computer system for selecting tag SNPs for constituting a group of nucleic acid probes corresponding to the tag SNPs, the tag SNPs being used for performing imputation of information on SNPs of human genome, by using human genome information which includes information on a group of SNPs of which genotypes are identified in multiple individuals, the computer system comprising a recording unit and an arithmetic processing unit, wherein:
(A) the recording unit records at least following information (1) to (4), which are read out from the human genome information and represent information on tag SNP candidates and information on target SNPs positioned in vicinity which is defined within a prescribed range from gene loci of the tag SNP candidates:
(1) gene loci of the tag SNP candidates on human genome;
(2) genotypes of the tag SNP candidates in the individual human genome information;
(3) gene loci of the target SNPs on human genome; and
(4) genotypes of the target SNPs in the individual human genome information;
(B) the arithmetic processing unit calculates a sum of mutual informations between each of the tag SNP candidates and the corresponding target SNPs, based on the information (1) to (4) in (A) obtained from the recording unit, and selects the tag SNP candidate having the maximum sum among the tag SNP candidates as a first tag SNP;
(C) the step of (B) is repeated to select the tag SNP candidate having the maximum sum of the mutual informations as a second tag SNP based on the information on tag SNPs and the information on target SNPs, from which information on the tag SNP which has been already selected and the corresponding group of target SNPs is removed; and
(D) the steps of (B) and (C) are repeated remaining M minus 2 times to select an Mth (M is a natural number) tag SNP until a value of the natural number M reaches a determined intended number of the tag SNPs for imputation.

15. The computer system for selecting tag SNPs according to claim 14,
wherein the human genome information is human genome database information comprising information on a group of SNPs of which genotypes are identified in multiple individuals.

16. The computer system for selecting tag SNPs according to claim 14,
wherein the arithmetic processing unit calculates the mutual information under a premise that genotypes of a group of SNPs subjected to the calculation are determined, and (1) frequency of genotype of each of the tag SNP candidates, (2) frequency of genotype of each of the target SNPs positioned in vicinity which is defined within a prescribed range from gene locus of each of the tag SNP candidates, and (3) frequencies of combinations of genotypes of the tag SNP candidates and genotypes of the target SNP candidates, are calculated.

17. The computer system for selecting tag SNPs according to claim 14,
wherein the group of target SNPs used for calculating the sum of the mutual informations for each tag SNP candidate are pre-selected by an index other than the mutual information.

18. The computer system for selecting tag SNPs according to claim 17,
wherein the index other than the mutual information is a linkage disequilibrium value between each of the tag SNP candidates and the group of target SNPs positioned in vicinity which is defined within a prescribed range from a gene locus of each of the tag SNP candidates.

19. The computer system for selecting tag SNPs according to claim 18,
wherein the linkage disequilibrium value is an r² linkage disequilibrium value.

20. The computer system for selecting tag SNPs according to claim 14,
wherein the vicinity which is defined within a prescribed range is a region within 500 kbps from a base of each tag SNP toward an upstream and downstream sides.

21. The computer system for selecting tag SNPs according to claim 14,
wherein the number of the tag SNPs which are used for the imputation and are selected for the nucleic acid probes is a number or more by which a result of the imputation performed by the tag SNPs satisfies specified performance.

22. The computer system for selecting tag SNPs according to claim 21,
wherein the specified performance is a condition in which an average square value of correlation coefficients between genotypes of SNPs having an MAF of 5%, estimated by the imputation, and actual genotypes of the SNPs is 0.94 or higher.

23. The computer system for selecting tag SNPs according to claim 14,
wherein, one or more kinds of other SNPs are selected separately from the selection of the tag SNPs performed by the computer system, and are preferentially incorporated as SNPs characterizing the nucleic acid probes.

24. The computer system for selecting tag SNPs according to claim 14,
wherein the group of nucleic acid probes is a group of nucleic acid probes to be mounted on a DNA microarray.

25. A computer program for selecting tag SNPs for constituting a group of nucleic acid probes corresponding to the tag SNPs, the tag SNPs being used for performing imputation of information on SNPs of human genome, by using human genome information which includes information on a group of SNPs of which genotypes are identified in multiple individuals, the computer program comprising an algorithm that allows a computer to realize:
(A) a first function in which following information (1) to (4) is read out from a recording unit to be processed by an arithmetic processing unit, the information (1) to (4) being read out from the human genome information to be recorded in the recording unit, and representing information on the tag SNP candidates and information on target SNPs positioned in vicinity which is defined within a prescribed range from gene loci of the tag SNP candidates:
(1) gene loci of the tag SNP candidates on human genome;
(2) genotypes of the tag SNP candidates in the individual human genome information;
(3) gene loci of the target SNPs on human genome; and
(4) genotypes of the target SNPs in the individual human genome information;
(B) a second function in which a sum of mutual informations between each of the tag SNP candidates and the corresponding target SNPs is calculated based on the information (1) to (4) read out by the first function, and the tag SNP candidate having the maximum sum among the tag SNP candidates is selected as a first tag SNP; and
(C) a third function in which the tag SNP candidate having the maximum sum of the mutual informations is selected again as a second tag SNP by the second function, based on the information on tag SNPs and the information on target SNPs, from which information on the tag SNP which has been already selected and the corresponding group of target SNPs is removed, and then the steps of (B) and (C) are repeated remaining M minus 2 times to select an Mth (M is a natural number) tag SNP until a value of the natural number M reaches a determined intended number of the tag SNPs for imputation.

26. The computer program according to claim 25,
wherein the human genome information is human genome database information comprising information on a group of SNPs of which genotypes are identified in multiple individuals.

27. The computer program according to claim 25,
wherein the second function comprises an algorithm for calculating (1) frequency of the genotype of each of the tag SNP candidates, (2) frequency of the genotype of each of the target SNPs positioned in vicinity which is defined within a prescribed range from gene locus of each of the tag SNP candidates, and (3) frequencies of combinations of the genotypes of the tag SNP candidates and the genotypes of target SNP candidates.

28. The computer program according to claim 25,
wherein, in a pre-stage of the algorithm for realizing the second function, an algorithm for realizing preliminary selection of a group of target SNP candidates subjected to the second function by selecting the SNP candidates by an index other than the mutual information, is provided.

29. The computer program according to claim 28,
wherein the index other than the mutual information is a linkage disequilibrium value between each of the tag SNP candidates and the group of target SNPs positioned in vicinity which is defined within a prescribed range from a gene locus of each of the tag SNP candidates.

30. The computer program according to claim 29,
wherein the linkage disequilibrium value is an r² linkage disequilibrium value.

31. The computer program according to claim 25,
wherein the vicinity which is defined within a prescribed range is a region within 500 kbps from a base of each tag SNP toward an upstream and downstream sides.

32. The computer program according to claim 25,
wherein the number of the tag SNPs which are used for the imputation and selected for the nucleic acid probes is a number or more by which a result of the imputation performed by the tag SNPs satisfies specified performance.

33. The computer program according to claim 32,
wherein the specified performance is a condition in which an average square value of correlation coefficients between genotypes of SNPs having an MAF of 5%, estimated by the imputation, and actual genotypes of the SNPs is 0.94 or higher.

34. The computer program according to claim 25, comprising an algorithm that realizes that one or more kinds of other SNPs are selected separately from the selection of the tag SNPs and are preferentially identified as SNPs to be selected.

35. The computer program according to claim 25,
wherein the group of nucleic acid probes is a group of nucleic acid probes to be mounted on a DNA microarray.

36. A computer readable recording medium recording the computer program according to claim 25.

37. The computer system for selecting tag SNPs according to claim 14, executing a computer program for selecting tag SNPs for constituting a group of nucleic acid probes corresponding to the tag SNPs, the tag SNPs being used for performing imputation of information on SNPs of human genome, by using human genome information which includes information on a group of SNPs of which genotypes are identified in multiple individuals, the computer program comprising an algorithm that allows a computer to realize:
(A) a first function in which following information (1) to (4) is read out from a recording unit to be processed by an arithmetic processing unit, the information (1) to (4) being read out from the human genome information to be recorded in the recording unit, and representing information on the tag SNP candidates and information on target SNPs positioned in vicinity which is defined within a prescribed range from gene loci of the tag SNP candidates:
(1) gene loci of the tag SNP candidates on human genome;
(2) genotypes of the tag SNP candidates in the individual human genome information;
(3) gene loci of the target SNPs on human genome; and
(4) genotypes of the target SNPs in the individual human genome information;
(B) a second function in which a sum of mutual information between each of the tag SNP candidates and the corresponding target SNPs is calculated based on the information (1) to (4) read out by the first function, and the tag SNP candidate having the maximum sum among the tag SNP candidates is selected as a first tag SNP; and
(C) a third function in which the tag SNP candidate having the maximum sum of the mutual information is selected again as a second tag SNP by the second function, based on the information on tag SNPs and the information on target SNPs, from which information on the tag SNP which has been already selected and the corresponding group of target SNPs is removed, and then the steps of (B) and (c) are repeated remaining M minus 2 times to select an Mth (M is a natural number) tag SNP until a value of the natural number M reaches a determined intended number of the tag SNPs for imputation.

38. The computer system for selecting tag SNPs according to claim 14, wherein the human genome information is derived from specific race or a group of humans belonging to a category smaller than the race.
